(19) United States
(12) Patent Application Publication
(10) Pub. No.: US 2026/0302807 A1
(43) Pub. Date: Oct. 1, 2026

(54) PRE-CHARGE CIRCUITS ON BOTH LOW-SIDE SWITCH AND HIGH-SIDE SWITCH

(71) Applicant: Caterpillar Inc., Peoria, IL (US)

(72) Inventor: Gowan J. Woolley, Great Dunmow (GB)

(73) Assignee: Caterpillar Inc., Peoria, IL (US)

(21) Appl. No.: 19/092,476

(22) Filed: Mar. 27, 2025

(51) Int. Cl. H02J 7/62; H01M 10/42; H01M 10/44; H01M 50/507; H02J 7/50; H02J 105/37

(52) U.S. Cl. CPC H02J 7/62; H01M 10/425; H01M 10/441; H01M 50/507; H02J 7/50; H02J 2105/37

(57) ABSTRACT

Techniques to extend the working life of an electrically controllable switch that is coupled in a parallel configuration with a pre-charge circuit. A pre-charge strategy includes both a high side switch (HSS) and low side switch (LSS). This design allows sharing the operational life across all HV contactors as opposed to just the one as in existing designs. In addition, the additional HSS/LSS pre-charge circuit may be used to safely confirm the working condition, e.g., welded, of an opposing contact.

### FIELD OF THE DISCLOSURE

This document pertains generally, but not by way of limitation, to techniques to limit inrush current when connecting a power source to a load.

### BACKGROUND

A pre-charge circuit is an electrical circuit designed to gradually charge capacitors or power rails to a predefined voltage level before full power is applied. This is important in systems that use high-power components, such as electric vehicles, industrial machines, and motor drives. Without a pre-charge circuit, turning on a system suddenly may result in a large inrush current due to the charging of capacitors, which may cause excessive stress on power components, fuses, and switches, potentially reducing lifespan or even leading to failures. A pre-charge circuit is typically coupled in parallel with a contact, where the pre-charge circuit includes a resistor and a controlled switch that limits the initial current flow. This allows the voltage to rise smoothly before the contact closes, ensuring a controlled power-up sequence.

Pre-charge circuits are used in machines to ensure safe and efficient operation of power electronics and energy storage systems. In electric vehicles, for example, they prevent large current surges when connecting the high-voltage battery to the inverter. Similarly, in industrial automation and large motor drives, pre-charge circuits help protect power transistors and avoid voltage dips that could disrupt other components. The typical operation involves an initial pre-charge phase, where current flows through a resistor to gradually charge the system. Once the voltage reaches a safe level, the main contact closes, bypassing the pre-charge circuit and allowing full power flow. Afterward, the pre-charge circuit disengages to prevent unnecessary power dissipation. By controlling inrush currents and voltage transients, pre-charge circuits enhance the reliability, longevity, and efficiency of modern electrical machines and systems.

US11451138 discloses driver circuits having a high-side switch and a low-side switch. A pre-charging circuit is provided to pre-charge the low-side switch. In other implementations, methods are disclosed which involve pre-charging a low-side switch.

### SUMMARY OF THE DISCLOSURE

This disclosure describes various techniques to extend the working life of an electrically controllable switch that is coupled in a parallel configuration with a pre-charge circuit. The present inventor has recognized that by using a pre-charge strategy that includes both a high side switch (HSS) and low side switch (LSS), the wetting current applied to the main current carrying electrically controllable switches, e.g., contact of a contactor, may be controlled to keep the contact in the optimum operating range by adjusting the voltage at which the contactor is energized. This design allows sharing the operational life across all HV contactors as opposed to just the one as in existing designs. In addition, the additional HSS/LSS pre-charge circuit may be used to safely confirm the working condition, e.g., welded, of an opposing contact.

In some aspects, this disclosure is directed to a battery system configured to improve contactor life, the battery system comprising: a battery pack electrically coupled with a first voltage bus and a second voltage bus including: a first battery string having at least one first battery cell, wherein the first battery string is electrically coupled between the first voltage bus and the second voltage bus; a first side coupled with the first voltage bus; and a second side coupled with the second voltage bus; at least one contactor including: a first contact electrically coupled with the first voltage bus, wherein the first contact is configured to selectively isolate the first side of the battery pack from a load, wherein the first contact divides the first voltage bus into a first side and a second side, wherein the first side of the first voltage bus is coupled with the battery pack and the second side of the first voltage bus is configured to be coupled with the load; a second contact coupled with the first battery string between the second side of the battery pack and the second voltage bus, wherein the second contact is configured to selectively isolate the first battery string from the load; a first pre-charge circuit coupled in a parallel configuration with the first contact; and a second pre-charge circuit coupled in a parallel configuration with the second contact.

In some aspects, this disclosure is directed to a method for improving a working life of an electrically controllable switch, the method comprising: coupling a first pre-charge circuit in a parallel configuration with a first electrically controllable switch; coupling a second pre-charge circuit in a parallel configuration with a second electrically controllable switch; and selectively enabling the first pre-charge circuit or the second pre-charge circuit when a power source is coupled with a load.

In some aspects, this disclosure is directed to a method for determining whether an electrically controllable switch in a circuit configured to couple a power source to a load of a machine is operational, the method comprising: selectively enabling either: a first pre-charge circuit coupled in a parallel configuration with a first electrically controllable switch; or a second pre-charge circuit coupled in a parallel configuration with a second electrically controllable switch, while ensuring that the other remains disabled; measuring an electrical parameter associated with the load of the machine; and determining, based on the measured electrical parameter, whether the first electrically controllable switch or the second electrically controllable switch is operational.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a perspective view of an example of an electric machine (at least partially battery powered) that may implement various techniques of this disclosure.

FIG. 2 is a simplified schematic diagram of an example of a portion of a battery system that may implement various techniques of this disclosure.

FIG. 3 is a flow diagram of an example of a method for improving a working life of an electrically controllable switch.

FIG. 4 is a flow diagram of an example of a method for determining whether an electrically controllable switch in a circuit configured to couple a power source to a load is operational.

### DETAILED DESCRIPTION

In high-power electric machine systems that are at least partially battery-powered, it is desirable to pre-charge the inverter before coupling the battery pack to the load via electrically controllable switches, e.g., contact of a contactor, field-effect transistor (FET), insulated gate bipolar transistor (IGBT), and the like. Before connecting the two together, there is a high voltage on one side, e.g., 600 volts, and zero volts on the other side. Without a pre-charge capability, closure of the controllable switch results in the high-voltage (HV), e.g., 600 volts, generated across the switch with very high current. The voltage and current are sufficient to weld the switch closed, for example, and make it inoperable.

Existing systems that connect a power source to a load include a pre-charge circuit on either the positive side or the negative side, but not both. The present inventor has recognized that a problem with such existing systems is that the same electrically controllable switch carries the load current every time the load is coupled to the power source, e.g., a battery pack. The present inventor has recognized a need to improve the working life of the electrically controllable switch.

This disclosure describes various techniques to extend the working life of an electrically controllable switch that is coupled in a parallel configuration with a pre-charge circuit. The present inventor has recognized that by using a pre-charge strategy that includes both a high side switch (HSS) and low side switch (LSS), the wetting current applied to the main current carrying electrically controllable switches, e.g., contact of a contactor, may be controlled to keep the contact in the optimum operating range by adjusting the voltage at which the contactor is energized. This design allows sharing the operational life across all HV contactors as opposed to just the one as in existing designs. In addition, the additional HSS/LSS pre-charge circuit may be used to safely confirm the working condition, e.g., welded, of an opposing contact.

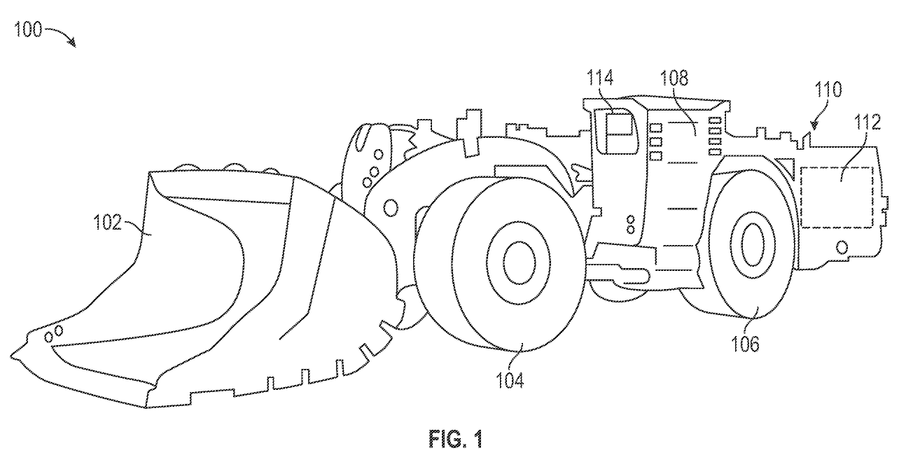

FIG. 1 is a perspective view of an example of an electric machine 100 that may implement various techniques of this disclosure. In some examples, the electric machine 100 is at least partially battery-powered. FIG. 1 depicts a non-limiting view of an electric machine 100 in the form of a load-haul-dump (LHD) vehicle, such as for mining, including a dump bucket 102, wheels 104, 106, an operator control cabin 108, and a vehicle body 110. The wheels 104, 106 are examples of traction components. In other examples, the electric machine 100 may include traction components such as one or more tracks, in addition to or instead of the wheels.

The electric machine 100, e.g., an electric mine truck, also includes an electrical system 112. The electrical system 112 may include a DC power source, including but not limited to one or more battery strings, which may supply power to, among other things, an electric motor. The electric motor may supply rotational power to one or more systems, such as a system configured to operate various hydraulics of the dump bucket 102. The electrical system 112 may supply power to at least one traction component, such as the wheel 104, 106, and to at least one accessory component 114, such as a pump motor, fan, and the like.

In some examples, the electric machine 100 may include electric vehicles, such as cars, trucks, motorcycles, buses, and the like. Although the techniques of this disclosure may be especially suited for use in machines that are at least partially battery-powered, the techniques are not limited to use with such machines. Rather, the techniques are applicable when connecting a power source with a load.

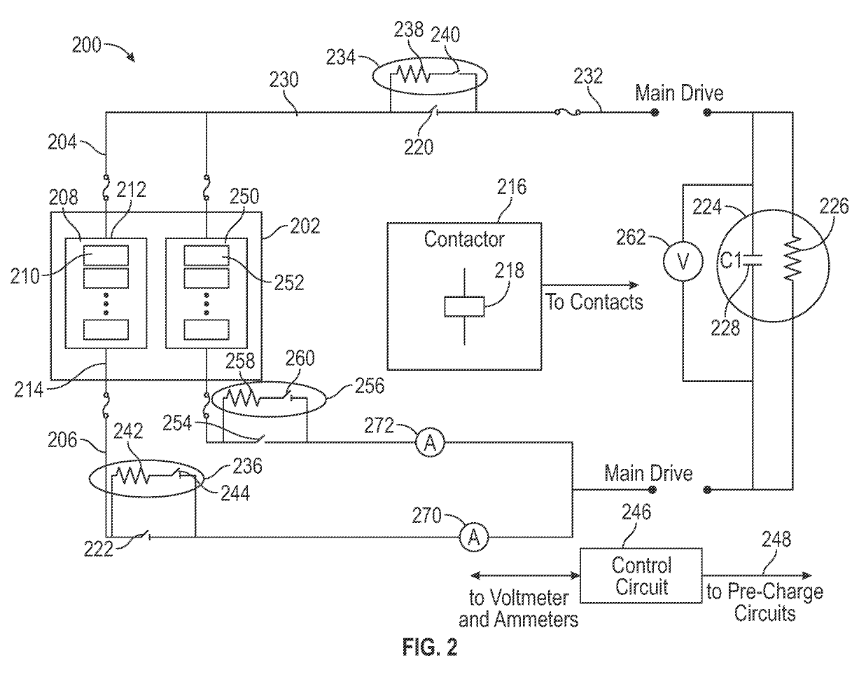

FIG. 2 is a simplified schematic diagram of an example of a portion of a system 200 that may implement various techniques of this disclosure. In some examples, the system 200 is a battery system, such as shown in FIG. 2. The system 200 includes a battery pack 202 electrically coupled with a first voltage bus 204, e.g., positive bus, and a second voltage bus 206, e.g., negative bus. The battery pack 202 includes a first battery string 208 having at least one battery cell 210. The first battery string 208 is electrically coupled between the first voltage bus 204 and the second voltage bus 206. The battery pack 202 has a first side 212, e.g., positive terminal, coupled with the first voltage bus 204 and a second side 214, e.g., negative terminal, coupled with the second voltage bus 206.

The system 200 includes one or more contactors, such as the contactor 216. The contactor 216 includes a coil 218 and one or more contacts that operate when the coil 218 is energized. For example, the contactor 216 includes a first contact 220 electrically coupled with the first voltage bus 204. The first contact 220 is configured to selectively isolate the first side 212 of the battery pack 202 from a load 224, such as a resistive-capacitive load 224 including a resistive element 226 and a capacitor 228. The first contact 220 divides the first voltage bus 204 into a first side 230 and a second side 232. The first side 230 of the first voltage bus 204 is coupled with the battery pack 202 and the second side 232 of the first voltage bus 204 is configured to be coupled with the load 224.

The contactor 216, or another contactor, includes a second contact 222 coupled with the first battery string 208 between the second side 214 of the battery pack 202 and the second voltage bus 206. The second contact 222 selectively isolates the first battery string 208 from the load 224.

In accordance with this disclosure, the system 200 includes two pre-charge circuits associated with the first contact 220 and the second contact 222, namely a first pre-charge circuit 234 associated with the first contact 220 and a second pre-charge circuit 236 associated with the second contact 222. The first pre-charge circuit 234 includes a resistive element 238 coupled in series with an electrically controllable switch 240, e.g., contact, FET, or IGBT, where the first pre-charge circuit 234 is coupled in a parallel configuration with the first contact 220 or other electrically controllable switch. Similarly, the second pre-charge circuit 236 includes a resistive element 242 coupled in series with an electrically controllable switch 244, where the second pre-charge circuit 236 is coupled in a parallel configuration with the second contact 222 or other electrically controllable switch.

The system 200 includes a control circuit 246 in electrical communication with the first pre-charge circuit 234 and the second pre-charge circuit 236. The control circuit 246 generates control signal 248 to selectively enable the first pre-charge circuit 234 or the second pre-charge circuit 236, while ensuring the other remains disabled. For example, the control circuit 246 generates control signal 248 to close the electrically controllable switch 240 and keep open the electrically controllable switch 244, thereby enabling the first pre-charge circuit 234 and ensuring that the second pre-charge circuit 236 remains disabled. By using a pre-charge strategy that includes both a high-side pre-charge circuit, namely the first pre-charge circuit 234, and a low-side pre-charge circuit, namely the second pre-charge circuit 236, the operational life of the first contact 220 and the second contact 222 is improved, in contrast to existing designs.

In some examples, the control circuit 246 selectively enables the first pre-charge circuit 234 or the second pre-charge circuit 236 by sequentially enabling the first pre-charge circuit or the second pre-charge circuit, such as when the battery pack 202 is coupled to the load 224, e.g., on every key cycle. That is, each time the power source, e.g., the battery pack 202, is coupled to the load 224, the control circuit 246 enables the first pre-charge circuit if the second pre-charge circuit was last selected. In this example with two pre-charge circuits, the sequence amounts to alternating between the two pre-charge circuits.

In some examples, the control circuit 246 selectively enables the first pre-charge circuit 234 or the second pre-charge circuit 236 after a time, where the time is based on a time constant. For example, the time constant is an RC time constant determined by a capacitance of the load 224 and a resistance of the enabled first pre-charge circuit 234 or the enabled second pre-charge circuit 236. This time constant allows the voltage difference across the first contact 220 or the second contact 222 to exponentially decrease over time to a level at which it is safe to close the contact without damage. In this manner, the time constant is used to keep the contact in its optimum operating range by adjusting the voltage at which the contactor is energized.

In some examples, the battery pack 202 further includes a second battery string 250 (or more than two battery strings) having at least one second battery cell 252, where the first battery string 208 and the second battery string 250 are coupled in a parallel configuration and are electrically coupled between the first voltage bus 204 and the second voltage bus 206. In such a configuration, such as shown in the system 200 of FIG. 2, the contactor 216 (or another contactor) includes a third contact 254 coupled with the second battery string 250 between the second side 214 of the battery pack 202 and the second voltage bus 206. The third contact 254 is configured to selectively isolate the second battery string 250 from the load 224. Like with the first contact 220 and the second contact 222, a third pre-charge circuit 256 is coupled in a parallel configuration with the third contact 254. The third pre-charge circuit 256 includes a resistive element 258 and an electrically controllable switch 260.

With the two battery strings and three pre-charge circuits, the control circuit 246 selectively enables the first pre-charge circuit 234, the second pre-charge circuit 236, or the third pre-charge circuit 256, as described above. In some examples, the control circuit 246 sequentially enables the first pre-charge circuit 234, the second pre-charge circuit 236, or the third pre-charge circuit 256, while ensuring that the others are disabled. With three pre-charge circuits, the enabling sequence may be the first pre-charge circuit 234 (with the second and third disabled), then the second pre-charge circuit 236 (with the first and third disabled), then the third pre-charge circuit 256 (with the first and second disabled), and back to the first pre-charge circuit 234. In some examples, this cycle of enablement repeats.

In the example shown in FIG. 2, there is one high-side contact, namely the first contact 220, and two low-side contacts, namely the second contact 222 and the third contact 254, for the two battery strings. In some examples, each battery string may have its own high-side contact and a low-side contact, rather than sharing a high-side contact like in FIG. 2.

Additionally, this disclosure describes techniques to test whether a contact of a contactor, such as the contactor 216, in the system 200 is welded closed. Because there is a pre-charge circuit associated with both the first contact 220 and the second contact 222, the control circuit 246 may determine whether the first contact 220 or the second contact 222 is welded closed. To test for a welded contact, the system 200 includes a voltmeter 262 coupled in a parallel configuration with the capacitor 228 of the load 224, where the voltmeter 262 is in communication with the control circuit 246. In some examples, the system 200 includes an ammeter 270 in the first battery string 208, where the ammeter 270 is in communication with the control circuit 246. In some examples with a second battery string 250, the system 200 may include an ammeter 272, where the ammeter 272 is in communication with the control circuit 246.

By way of a non-limiting example, to test whether the second contact 222 is welded closed, the control circuit 246 generates a signal to close the electrically controllable switch 240 of the first pre-charge circuit 234. If the second contact 222 is not welded closed, the voltmeter 262 coupled in a parallel configuration with the capacitor 228 of the load 224 indicates zero volts because no current is flowing through the circuit. The voltmeter 262 transmits the reading to the control circuit 246 and, in response, the control circuit 246 determines that the second contact 222 is not welded closed. Similarly, if present, the ammeter 270 indicates zero amps if the second contact 222 is not welded closed. The ammeter 270 transmits the reading to the control circuit 246 and, in response, the control circuit 246 determines that the second contact 222 is not welded closed. In some examples, one or both of the voltmeter 262 and the ammeter 270 are present and used by the control circuit 246 to determine whether a contact is welded closed.

If, however, the second contact 222 is welded closed, the voltmeter 262 coupled in a parallel configuration with the capacitor 228 of the load 224 measures a voltage as the capacitor 228 charges due to the current flowing through the circuit. The voltmeter 262 transmits the reading to the control circuit 246 and, in response, the control circuit 246 determines that the second contact 222 is welded closed. Similarly, if present, the ammeter 270 indicates that current is flowing in the circuit if the second contact 222 is welded closed. The ammeter 270 transmits the reading to the control circuit 246 and, in response, the control circuit 246 determines that the second contact 222 is welded closed.

The control circuit 246 may similarly test whether the first contact 220 is welded closed by using the second pre-charge circuit 236. Alternatively, if present, the third pre-charge circuit 256 may be used. In sum, to perform the test to confirm whether one of the first contact or the second contact is welded closed, the control circuit 246 enables a pre-charge circuit associated with the other one of the first contact and the second contact.

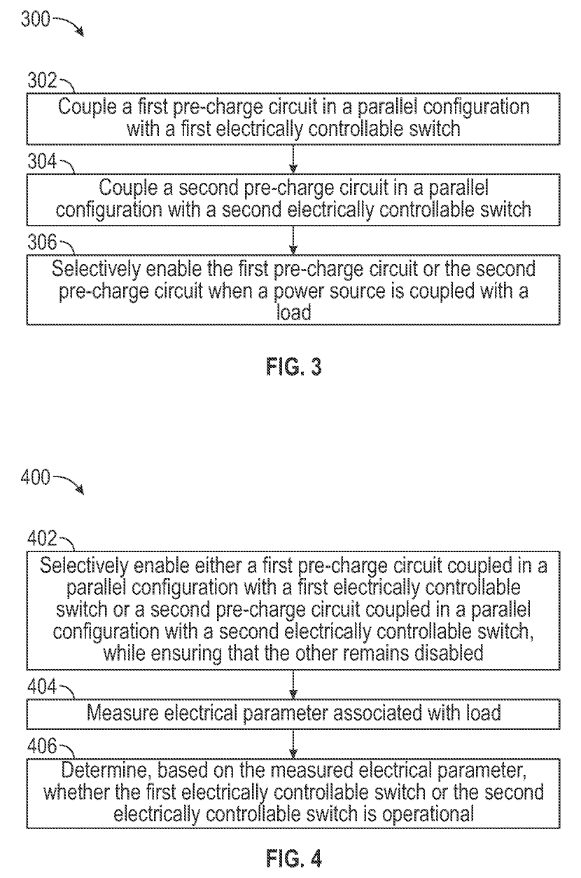

FIG. 3 is a flow diagram of an example of a method 300 for improving a working life of an electrically controllable switch. At block 302, the method 300 includes coupling a first pre-charge circuit in a parallel configuration with a first electrically controllable switch first contact of the contactor. For example, the first pre-charge circuit 234 of the system 200 in FIG. 2 is coupled in a parallel configuration with the first contact 220 of the contactor 216. In other examples, the first contact 220 may be a FET or IGBT, for example.

At block 304, the method 300 includes coupling a second pre-charge circuit in a parallel configuration with a second electrically controllable switch. For example, the second pre-charge circuit 236 of the system 200 in FIG. 2 is coupled in a parallel configuration with the second contact 222 of the contactor 216. In other examples, the second contact 222 may be a FET or IGBT, for example.

At block 306, the method 300 includes selectively enabling the first pre-charge circuit or the second pre-charge circuit when a power source is coupled with a load. For example, the control circuit 246 generates a control signal 248 to selectively enable first pre-charge circuit 234 when a power source, e.g., the battery pack 202, is coupled with the load 224, such as after a time, where the time is based on a time constant.

In some examples, selectively enabling the first pre-charge circuit or the second pre-charge circuit includes sequentially enabling the first pre-charge circuit or the second pre-charge circuit, such as enabling either the first pre-charge circuit or the second pre-charge circuit while ensuring the other remains disabled.

FIG. 4 is a flow diagram of an example of a method 400 for determining whether an electrically controllable switch in a circuit configured to couple a power source to a load is operational. At block 402, the method 400 includes selectively enabling either a first pre-charge circuit coupled in a parallel configuration with a first electrically controllable switch or a second pre-charge circuit coupled in a parallel configuration with a second electrically controllable switch, while ensuring that the other remains disabled. For example, the control circuit 246 selectively enables (closes) the first pre-charge circuit 234 associated with the first contact 220 while ensuring that the second pre-charge circuit 236 associated with the second contact 222 remains disabled (open).

At block 404, the method 400 includes measuring an electrical parameter associated with the load of the machine. For example, the control circuit 246 receives a voltage measurement from the voltmeter 262 and/or a current measurement from the ammeter 270, where the measured electrical parameter is associated with charging of the capacitor 228 of the load 224.

At block 406, the method 400 includes determining, based on the measured electrical parameter, whether the first electrically controllable switch or the second electrically controllable switch is operational. For example, the control circuit 246 determines, based on the measured voltage and/or current, whether the second contact 222 is operational.

### INDUSTRIAL APPLICABILITY

The high-side and low-side pre-charge switch system described above has particular applicability in high-power electric machine systems, such as mining vehicles that are at least partially battery-powered. The system operates to safely connect a high-voltage power source to a load while extending component life and providing fault detection capabilities.

In operation, when connecting a power source (e.g., 600V battery pack) to a load, the system selectively enables either the high-side pre-charge circuit or low-side pre-charge circuit while keeping the other disabled. The control circuit alternates between the pre-charge circuits on successive power-up cycles, distributing operational wear across multiple contacts rather than concentrating it on a single contact.

The system provides several operational capabilities. Welded contact detection is achieved by enabling one pre-charge circuit to test the opposing contact’s condition. If one contact fails, the system maintains limp-home functionality by utilizing the remaining operational pre-charge circuit. The alternating use of high-side and low-side pre-charge circuits extends contact life. Additionally, the system ensures safe connection of high-voltage sources by controlling inrush current through pre-charge resistors.

This pre-charge strategy is particularly beneficial in electric mining equipment and other high-power electric vehicles where reliable, long-lasting operation of high-voltage switching components is important for machine uptime and safety.

What is claimed is:

1. A battery system configured to improve contactor life, the battery system comprising:
a battery pack electrically coupled with a first voltage bus and a second voltage bus including:
a first battery string having at least one first battery cell, wherein the first battery string is electrically coupled between the first voltage bus and the second voltage bus;
a first side coupled with the first voltage bus; and
a second side coupled with the second voltage bus;
at least one contactor including:
a first contact electrically coupled with the first voltage bus, wherein the first contact is configured to selectively isolate the first side of the battery pack from a load, wherein the first contact divides the first voltage bus into a first side and a second side, wherein the first side of the first voltage bus is coupled with the battery pack and the second side of the first voltage bus is configured to be coupled with the load;
a second contact coupled with the first battery string between the second side of the battery pack and the second voltage bus, wherein the second contact is configured to selectively isolate the first battery string from the load;
a first pre-charge circuit coupled in a parallel configuration with the first contact; and
a second pre-charge circuit coupled in a parallel configuration with the second contact.

2. The battery system of claim 1, wherein the battery pack further includes a second battery string having at least one second battery cell, wherein the first battery string and the second battery string are coupled in a parallel configuration and are electrically coupled between the first voltage bus and the second voltage bus,
wherein the at least one contactor further includes a third contact coupled with the second battery string between the second side of the battery pack and the second voltage bus, wherein the third contact is configured to selectively isolate the second battery string from the load, and
wherein the battery system further includes a third pre-charge circuit coupled in a parallel configuration with the third contact.

3. The battery system of claim 1, comprising:
a control circuit in electrical communication with the first pre-charge circuit and the second pre-charge circuit, wherein the control circuit is configured for selectively enabling the first pre-charge circuit or the second pre-charge circuit.

4. The battery system of claim 3, wherein the control circuit configured for selectively enabling the first pre-charge circuit or the second pre-charge circuit is configured for:
sequentially enabling the first pre-charge circuit or the second pre-charge circuit.

5. The battery system of claim 4, wherein the control circuit configured for sequentially enabling the first pre-charge circuit or the second pre-charge circuit is configured for:
sequentially enabling the first pre-charge circuit or the second pre-charge circuit when the battery pack is coupled to the load.

6. The battery system of claim 3, wherein the control circuit configured for selectively enabling the first pre-charge circuit or the second pre-charge circuit is configured for:
enabling either the first pre-charge circuit or the second pre-charge circuit while ensuring the other remains disabled.

7. The battery system of claim 3, wherein the control circuit is configured for selectively enabling the first pre-charge circuit or the second pre-charge circuit after a time, wherein the time is based on a time constant.

8. The battery system of claim 7, wherein the time constant is determined by a capacitance of the load and a resistance of the enabled first pre-charge circuit or the enabled second pre-charge circuit.

9. The battery system of claim 3, wherein the control circuit is configured to determine whether one of the first contact or the second contact is welded closed.

10. The battery system of claim 9, wherein the control circuit configured to determine whether one of the first contact or the second contact is welded closed is configured to enable a pre-charge circuit associated with the other one of the first contact and the second contact.

11. A method for improving a working life of an electrically controllable switch, the method comprising:
coupling a first pre-charge circuit in a parallel configuration with a first electrically controllable switch;
coupling a second pre-charge circuit in a parallel configuration with a second electrically controllable switch; and
selectively enabling the first pre-charge circuit or the second pre-charge circuit when a power source is coupled with a load.

12. The method of claim 11, wherein the first electrically controllable switch is a first contact of a contactor, and wherein the second electrically controllable switch is a second contact of the contactor.

13. The method of claim 12, wherein the power source is a battery pack, wherein the first contact divides a first voltage bus into a first side and a second side, wherein the first side of the first voltage bus is coupled with the battery pack and the second side of the first voltage bus is configured to be coupled with the load; and
wherein the second contact is coupled with a first battery string of the battery pack between the second side of the battery pack and the second voltage bus, and wherein the second contact is configured to selectively isolate the first battery string from the load.

14. The method of claim 12, wherein selectively enabling the first pre-charge circuit or the second pre-charge circuit includes:
sequentially enabling the first pre-charge circuit or the second pre-charge circuit.

15. The method of claim 12, wherein selectively enabling the first pre-charge circuit or the second pre-charge circuit includes:
enabling either the first pre-charge circuit or the second pre-charge circuit while ensuring the other remains disabled.

16. A method for determining whether an electrically controllable switch in a circuit configured to couple a power source to a load of a machine is operational, the method comprising:
selectively enabling either:
a first pre-charge circuit coupled in a parallel configuration with a first electrically controllable switch; or
a second pre-charge circuit coupled in a parallel configuration with a second electrically controllable switch, while ensuring that the other remains disabled;
measuring an electrical parameter associated with the load of the machine; and
determining, based on the measured electrical parameter, whether the first electrically controllable switch or the second electrically controllable switch is operational.

17. The method of claim 16, wherein the electrical parameter is a voltage.

18. The method of claim 16, wherein the electrical parameter is a current.

19. The method of claim 16, wherein the first electrically controllable switch is a contact of a contactor.

20. The method of claim 16, comprising:
selectively enabling the first pre-charge circuit; and
determining, based on the measured electrical parameter, whether the second electrically controllable switch associated with the second pre-charge circuit is operational.
